(19) United States
(12) Patent Application Publication
(10) Pub. No.: US 2024/0026877 A1
(43) Pub. Date: Jan. 25, 2024

(54) PUMP HEAD ELEMENT AND PUMP HEAD COMPRISING SAME, AND CONTAINER

(71) Applicant: BEIJING RED-SEA TECH CO., LTD., Beijing (CN)

(72) Inventors: Zengxin CHEN, Beijing (CN); Shenglu LI, Beijing (CN); Jiansong XIA, Beijing (CN); Chen LI, Beijing (CN); JINxia WEI, Beijing (CN); Changchun ZHOU, Beijing (CN); Haiming WEI, Beijing (CN); Jingzhe CHEN, Beijing (CN); Bin CHEN, Beijing (CN)

(73) Assignee: BEIJING RED-SEA TECH CO., LTD., Beijing (CN)

(21) Appl. No.: 18/335,964

(22) Filed: Jun. 15, 2023

Related U.S. Application Data
(63) Continuation of application No. PCT/CN2021/138443, filed on Dec. 15, 2021.

(30) Foreign Application Priority Data
Dec. 15, 2020 (CN) 202011483030.4
Dec. 15, 2020 (CN) 202023012917.3

(51) Int. Cl. F04B 53/00; F04B 53/14; F04B 19/22; F04B 39/00

(52) U.S. Cl. CPC F04B 53/007; F04B 53/14; F04B 19/22; F04B 39/0061

(57) ABSTRACT

A pump head element and a pump head comprising same, and a container. The pump head element comprises a buffer liquid portion (11), an opening portion (12), and a closed end (13); the opening portion (12) has one end communicated with the buffer liquid portion (11) and the other end connected to the closed end (13); the internal space of the buffer liquid portion (11) and the internal space of the opening portion (12) are defined as liquid storage space (14); the liquid storage space (14) has one end closed by an externally provided piston (2) and the other end closed by the closed end (13); and the opening portion (12) comprises an opening (15) through which liquid to be extracted enters or leaves the liquid storage space (14).

### BACKGROUND

### Technical Field

The present disclosure relates to a pump head element, a pump head comprising the pump head element, and a container, and in particular, to a pump head element suitable for large-scale industrial production and assembly, a pump head comprising the pump head element, and a container.

### Related Art

Pump heads are often-used products in people's lives. Many liquid or paste products may be extracted from containers using the pump heads.

Existing pump heads are not high in price, but have many elements, and material costs and assembly costs occupy a large proportion in production costs. However, in order to reduce the number of elements, the pump heads are required to be reorganized structurally with high research and development costs and high difficulty, and therefore, few people are willing to perform the structure reorganization. Therefore, although the pump head technology is a traditional technology, is widely used, and has mature production process, the pump head structure has rarely been substantially improved for decades, and pump head elements have rarely changed.

Existing pump head components may be made of a variety of materials, such as plastics, metal springs, and glass beads, where there may be a variety of plastics. It is inconvenient to reuse a variety of materials after recycling, which is not conducive to recycling of the materials and handling of environmental problems such as plastic pollution.

In addition, different elements have different structures and shapes, and the performances of pump heads formed in combination with other elements will be different. At present, there are many problems in commonly used pump heads, such as poor air tightness when not used for a long time, influence in controllability caused by large spring elasticity, small volume for a single extraction, and non-extraction of liquid with high viscosity and consistency. How to improve the operation feel and extraction performance is also the main means to improve the competitiveness of products.

With the improvement of people's living standards and the enhancement of environmental protection awareness, pump heads and containers with lower manufacturing cost, convenient recycling and better performance are required, so as to improve the operation feel in extraction and use processes and the fluid extraction performance of the pump heads.

### SUMMARY

In order to solve the problems of high manufacturing cost and poor performance of pump heads in the related art, the present disclosure provides a pump head element. The pump head element includes a liquid buffer portion, an opening portion, and a closed end.

The opening portion has both an end communicated with the liquid buffer portion and an end connected to the closed end.

Internal spaces of the liquid buffer portion and the opening portion are defined as a liquid storage space.

The liquid storage space has both an end closed by an external piston and an end closed by the closed end.

The opening portion is provided with openings, and liquid to be extracted enters or leaves the liquid storage space via the openings.

The liquid storage space of the pump head element is capable of temporarily storing liquid to be extracted. One end of the liquid storage space is closed by the external piston, and the liquid will not enter or leave the end. The other end of the liquid storage space is closed by the closed end. The liquid buffer portion and the opening portion are directly connected, and the internal spaces are communicated with each other.

The opening portion is provided with openings, and liquid to be extracted enters or leaves the liquid buffer portion and the opening portion via the openings.

The openings of the pump head element may be a plurality of openings at the same axial position of the opening portion. The diameter of the opening portion in communication with an external channel can be increased by the plurality of openings, thereby preventing blockage caused by high-consistency and large-particle fluid, and reducing flow pressure losses.

The openings of the opening portion of the pump head element have a smaller aperture than other parts of the opening portion. An annular or grooved channel may be formed to be more smoothly communicated with the external channel.

The liquid buffer portion, the opening portion, and the closed end of the pump head element coincide axially. The axial coincidence of the liquid buffer portion, the opening portion, and the closed end of the pump head element facilitates mechanical assembly with other pump head assemblies, and is also beneficial to axial motion of the pump head element.

The liquid buffer portion of the pump head element is cylindrical, is externally provided with a protrusion, and is internally provided with a smooth surface matching the piston. The liquid buffer portion is cylindrical, which facilitates processing and production, and is also beneficial to maximizing capacity. The liquid buffer portion is externally provided with the protrusion matching a bracket, whereby an axial movement distance of the pump head element can be limited. The protrusion may be a blocking member arranged specially, or the liquid buffer portion may be used as a blocking member by utilizing a diameter difference between the liquid buffer portion and peripheral components. For example, both ends of the liquid buffer portion may be used as blocking members. The liquid buffer portion is internally provided with the smooth surface matching the piston, which can guarantee the air tightness of a pump head and realize the function of pumping liquid out.

The liquid buffer portion is partially peripherally provided with a smooth support surface parallel to the axis of the liquid buffer portion. The support surface supports the whole axial reciprocating movement of the pump head element. The support surface includes a peripheral surface of the liquid buffer portion and a peripheral surface of a joint between the liquid buffer portion and the opening portion. And after being combined with an external support member, the support surface supports the short-distance axial reciprocating movement of the pump head element to prevent the non-axial shaking of the pump head element. The smooth surface is beneficial to supporting the axial reciprocating movement of the pump head element.

The liquid buffer portion of the pump head element has a greater diameter than the opening portion and the closed end. More liquid may be temporarily stored due to a large diameter of the liquid buffer portion, and the pump head is capable of extracting more liquid in a single extraction. The material, space, and assembly costs can be saved due to small diameters of the opening portion and the closed end.

Both axial sides of the openings of the pump head element are provided with positions for mounting sealing components; or, both axial sides of the openings are provided with convex rib rings for fixing the sealing components. In this way, the number of sealing components can be reduced, and a sealing effect can be ensured. Also, the axial motion thereof is facilitated.

The pump head element is simple in structure, multifunctional, and mass-producible. The production cost can be reduced due to no requirements on product materials. A small number of simple components are required to match the pump head element, thus facilitating production and assembly. Mixed functions realizable by a plurality of components of existing pump heads can be realized. The present disclosure further provides a pump head. The pump head is provided with the pump head element.

The present disclosure further provides a container. The container is provided with the pump head.

The pump head and the container overcome various problems in existing containers, and have the advantages of few assemblies, convenient assembly, convenient use, extraction of contents with large viscosity and consistency, strong practicability, and the like. Also, the pump head and the container are made of a single material, which is recyclable again and is beneficial to reducing the environmental pollution pressure caused by plastics.

### BRIEF DESCRIPTION OF THE DRAWINGS

FIG. 1 is a sectional view of a pump head of Embodiment 1.

FIG. 2 is an exploded view of the pump head of Embodiment 1 in FIG. 1.

FIG. 3 is a sectional view of a pump head of Embodiment 2.

FIG. 4 is an exploded view of the pump head of Embodiment 2 in FIG. 3.

FIG. 5 is a sectional view and an exploded view of a pump head of Embodiment 3.

FIG. 6 is a perspective view and an exploded view of the pump head of Embodiment 3.

FIG. 7 is a sectional view and an exploded view of a pump head of Embodiment 4.

FIG. 8 is a perspective view and an exploded view of the pump head of Embodiment 4.

### DETAILED DESCRIPTION

### Embodiment 1

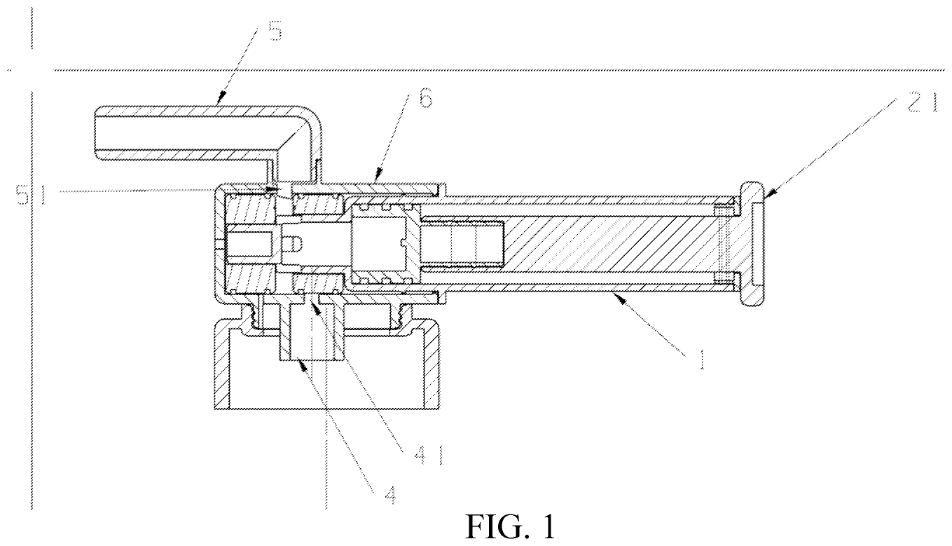

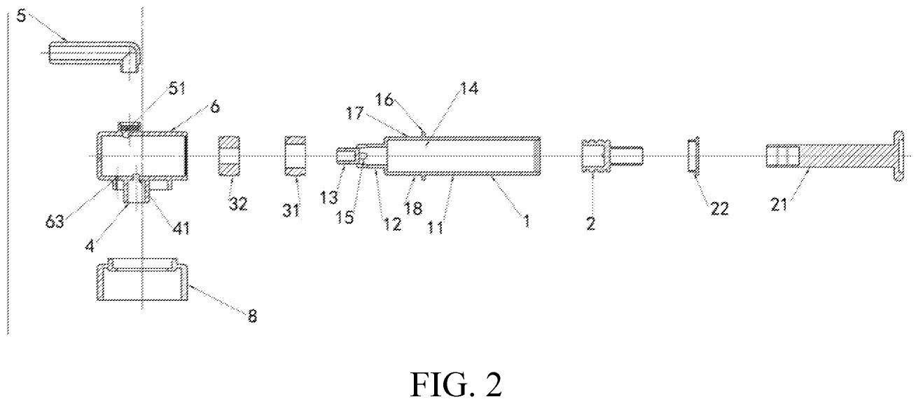

FIG. 1 shows a sectional view of a pump head according to Embodiment 1. FIG. 2 is an exploded view of FIG. 1. The pump head includes an axial motion assembly 1 (namely, a pump head element), a piston 2, a sealing component 31, a sealing component 32, a liquid suction channel 4, an outlet 41 of the liquid suction channel, an outflow channel 5, an inlet 51 of the outflow channel, a bracket 6, a connecting rod 21, a guide cover 22, and a container cover 8.

The axial motion assembly 1 includes a liquid buffer portion 11, an opening portion 12, and a closed end 13. The opening portion 12 has both an end communicated with the liquid buffer portion 11 and an end connected to the closed end 13. The liquid buffer portion 11 is cylindrical, is externally provided with a protrusion comprising a blocking ring 16 and a rib 17, and is internally provided with a smooth surface matching the piston 2. Internal spaces of the liquid buffer portion 11 and the opening portion 12 are defined as a liquid storage space 14. The liquid storage space 14 has both an end closed by the piston 2 and an end closed by the closed end 13. The opening portion 12 is provided with a plurality of openings 15, and liquid to be extracted enters or leaves the liquid storage space 14 via the openings 15. The axial motion assembly 1 is externally provided with the blocking ring 16 and the rib 17, and the axial motion assembly 1 is partially peripherally provided with a smooth support surface 18 parallel to the axis of the liquid buffer portion.

The liquid buffer portion 11, the opening portion 12, and the closed end 13 coincide axially. The plurality of openings 15 are provided at the same axial position of the opening portion. The liquid buffer portion 11 is externally provided with the protrusion comprising the blocking ring 16 and the rib 17. The protrusion matches the bracket 6 to limit an axial movement distance of the axial motion assembly 1. The axial motion assembly 1 is partially peripherally provided with the support surface 18 capable of supporting the whole axial reciprocating motion of the axial motion assembly 1. Both axial sides of the openings 15 are provided with positions for mounting a sealing ring 31 and a sealing ring 32. The positions are provided with rib rings for fixing the sealing ring 31 and the sealing ring 32, respectively. The sealing ring 32 is located on the closed end 13. The liquid buffer portion 11 has a greater aperture than the opening portion 12, and the opening portion 12 has a greater aperture than the closed end 13. The guide cover 22 is beneficial for the connecting rod 21 to maintain linear motion without shaking. An air return channel 63 has both an end opened in the bracket 6 and located below the sealing ring 32 and an end communicated with the interior of the container cover 8.

The piston 2 is pulled out of the axial motion assembly 1 by the connecting rod 21. The axial motion assembly 1 moves right, whereby the openings 15 are communicated with the liquid suction channel 4. The air return channel 63 is opened. The piston 2 is continuously pulled, the rib 17 is blocked by a chamfer inside a mounting port on the right of the bracket 6, and the axial motion assembly 1 does not move right any longer. Under the continuous pulling of the piston 2, liquid to be extracted enters the liquid storage space 14 from the liquid suction channel 4 via the openings 15.

The piston 2 is pulled into the axial motion assembly 1 by the connecting rod 21. The axial motion assembly 1 moves left, whereby the openings 15 are communicated with the outflow channel 5. The air return channel 63 is closed by the sealing ring 32. The piston 2 is continuously pulled, the blocking ring 16 is blocked by the mounting port on the right of the bracket 6, and the axial motion assembly 1 does not move left any longer. The piston 2 pushes liquid in the liquid storage space 14 to flow out from the outflow channel 5 via the openings 15.

The axial motion assembly 1 is simple in structure, multifunctional, and mass-producible. The production cost can be reduced due to no high requirements on product materials. A small number of simple components are required to match the pump head element, thus facilitating production and assembly.

The pump head assembled and produced with the axial motion assembly 1 is the pump head described in Embodiment 1 of the present disclosure. The pump head in Embodiment 1 is mounted on a container body capable of holding liquid through the container cover 8, so as to form a container comprising the pump head. The pump head and the container thus have the advantages of few assemblies, convenient assembly, convenient use, extraction of contents with large viscosity and consistency, strong practicability, and the like. Also, the pump head and the container are made of a single material, which may both be plastics recyclable again.

### Embodiment 2

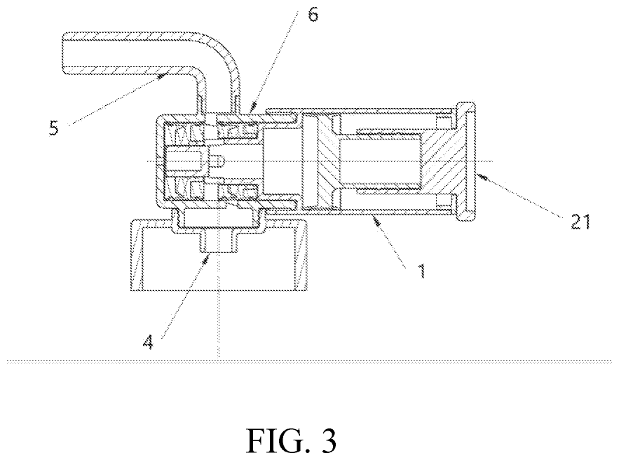

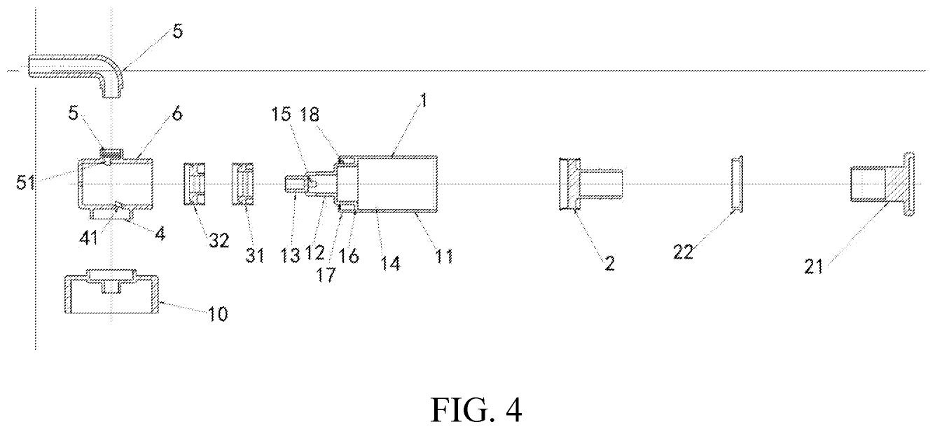

FIG. 3 shows a sectional view of a pump head according to Embodiment 2. FIG. 4 is an exploded view of FIG. 3. The pump head includes an axial motion assembly 1 (namely, a pump head element), a piston 2, a sealing component 31, a sealing component 32, a liquid suction channel 4, an outflow channel 5, a bracket 6, a connecting rod 21, and a cover 22.

The axial motion assembly 1 includes a liquid buffer portion 11, an opening portion 12, and a closed end 13. The opening portion 12 has both an end communicated with the liquid buffer portion 11 and an end connected to the closed end 13. The liquid buffer portion 11 is cylindrical, is externally provided with a protrusion comprising a shoulder 16 and a chamfer 17, and is internally provided with a smooth surface matching the piston 2. Internal spaces of the liquid buffer portion 11 and the opening portion 12 are defined as a liquid storage space 14. The liquid storage space 14 has both an end closed by the piston 2 and an end closed by the closed end 13. The opening portion 12 is provided with openings 15, and liquid to be extracted enters or leaves the liquid storage space 14 via the openings 15. The axial motion assembly 1 is externally provided with the shoulder 16 and the chamfer 17, and the axial motion assembly 1 is partially peripherally provided with a smooth support surface 18 parallel to the axis of the liquid buffer portion.

The liquid buffer portion 11, the opening portion 12, and the closed end 13 coincide axially. The plurality of openings 15 are provided at the same axial position of the opening portion 12. The liquid buffer portion 11 is externally provided with the protrusion comprising the shoulder 16 and the chamfer 17. The shoulder 16 and the chamfer 17 match the bracket 6 to limit an axial movement distance of the axial motion assembly 1. The axial motion assembly 1 is partially peripherally provided with the support surface 18. The support surface 18 supports the whole axial reciprocating motion of the axial motion assembly 1 on the bracket 6. Both axial sides of the openings 15 are provided with positions for mounting a sealing ring 31 and a sealing ring 32. The sealing ring 32 is located on the closed end 13. Both axial sides of the openings are provided with rib rings for fixing sealing components, which are configured to fix the sealing ring 31 and the sealing ring 32. The liquid buffer portion 11 has a greater aperture than the opening portion 12, and the opening portion 12 has a greater aperture than the closed end 13.

The piston 2 is pulled out of the axial motion assembly 1 by the connecting rod 21. The axial motion assembly 1 moves right, whereby the openings 15 are communicated with an outlet 41 of the liquid suction channel 4. The piston 2 is continuously pulled, the chamfer 17 is blocked by a rib outside a mounting port on the right of the bracket 6, and the axial motion assembly 1 does not move right any longer. Under the continuous pulling of the piston 2, liquid to be extracted enters the liquid storage space 14 from the liquid suction channel 4 via the openings 15.

The piston 2 is pulled into the axial motion assembly 1 by the connecting rod 21. The axial motion assembly 1 moves left, whereby the openings 15 are communicated with an inlet 51 of the outflow channel 5. The piston 2 is continuously pulled, the shoulder 16 is blocked by the mounting port on the right of the bracket 6, and the axial motion assembly 1 does not move left any longer. The piston 2 pushes liquid in the liquid storage space 14 to flow out from the outflow channel 5 via the openings 15.

Similarly, the axial motion assembly 1 in this embodiment is simple in structure, multifunctional, and mass-producible. The axial motion assembly is a core component of the pump head. The production cost can be reduced due to no high requirements on product materials. A small number of simple components are required to match the pump head element, thus facilitating production and assembly.

The pump head comprising the axial motion assembly 1 is the pump head described in Embodiment 2. The pump head in Embodiment 2 is mounted on a container body through the container cover 10, so as to form a container. The pump head in Embodiment 2 and the container comprising the pump head also have the advantages of few assemblies, convenient assembly, convenient use, extraction of contents with large viscosity and consistency, strong practicability, and the like. Also, the pump head and the container are made of a single material, which may both be plastics recyclable again.

### Embodiment 3

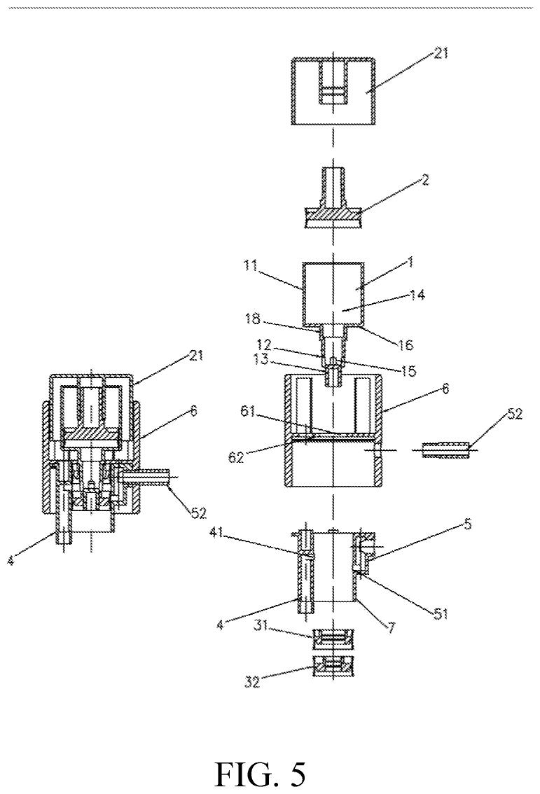

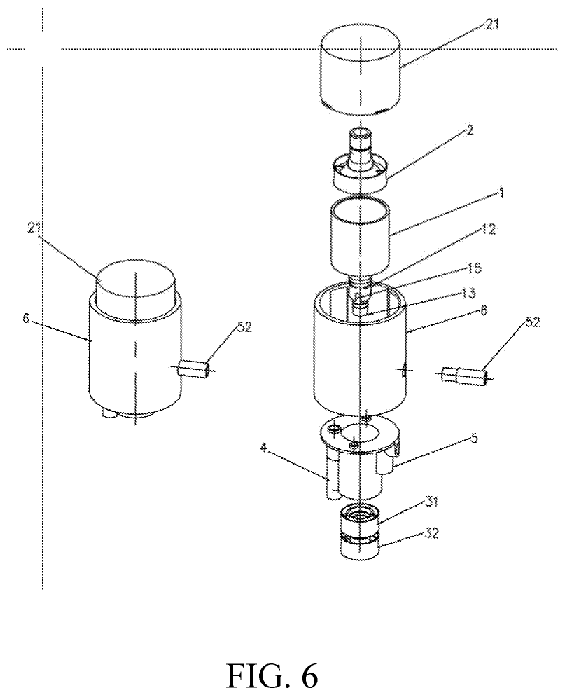

FIG. 5 and FIG. 6 show a pump head in Embodiment 3. FIG. 5 is a sectional view and an exploded view of a pump head of Embodiment 3. FIG. 6 is a perspective view and an exploded view of the pump head of Embodiment 3. The pump head includes an axial motion assembly 1 (namely, a pump head element), a piston 2, a sealing component 31, a sealing component 32, a liquid suction channel 4, an outflow channel 5, a bracket 6, and a connecting cover 21.

The axial motion assembly 1 includes a liquid buffer portion 11, an opening portion 12, and a closed end 13. The opening portion 12 has both an end communicated with the liquid buffer portion 11 and an end connected to the closed end 13. The liquid buffer portion 11 is cylindrical, is externally provided with a protrusion comprising a shoulder 16, and is internally provided with a smooth surface matching the piston 2. Internal spaces of the liquid buffer portion 11 and the opening portion 12 are defined as a liquid storage space 14. The liquid storage space 14 has both an end closed by the piston 2 and an end closed by the closed end 13. The opening portion 12 is provided with openings 15, and liquid to be extracted enters or leaves the liquid storage space 14 via the openings 15. The liquid buffer portion 11 of the axial motion assembly 1 has a greater diameter than the opening portion 12 to form the shoulder 16. A joint between the liquid buffer portion 11 and the opening portion 12 is partially peripherally provided with a smooth support surface 18 parallel to the axis of the liquid buffer portion. The diameter of a round hole 61 in the middle of the bracket 6 is slightly greater than that of the joint between the liquid buffer portion 11 and the opening portion 12. After the axial motion assembly 1 passes through the round hole 61 and is mounted on the bracket 6, both axial sides of the openings 15 are provided with rib rings on the opening portion 12 and the closed end 13, respectively, for fixing the sealing component 31 and the sealing component 32. In addition, an outlet 41 of the liquid suction channel 4 and an inlet 51 and an outlet 52 of the outflow channel 5 are further included.

In this embodiment, the liquid buffer portion 11, the opening portion 12, and the closed end 13 coincide axially. The plurality of openings 15 are provided at the same axial position of the opening portion 12. The shoulder 16 is formed outside the liquid buffer portion 11. The shoulder 16 and the sealing component 31 match the bracket 6 to limit an axial movement distance of the axial motion assembly 1. The joint between the liquid buffer portion 11 and the opening portion 12 is partially peripherally provided with the support surface 18. The support surface 18 guarantees the whole axial reciprocating motion of the axial motion assembly 1 on the bracket 6. Both axial sides of the openings 15 are provided with positions for mounting the sealing component 31 and the sealing component 32. The sealing component 32 is located on the closed end 13. The liquid buffer portion 11 has a greater aperture than the opening portion 12, and the opening portion 12 has a greater aperture than the closed end 13.

The piston 2 is pulled out of the axial motion assembly 1 by the connecting cover 21. The whole axial motion assembly 1 moves up, whereby the openings 15 are communicated with the liquid suction channel 4. After the sealing component 31 is blocked by a partition board 62 in the middle of the bracket 6, the axial motion assembly 1 does not move up any longer. As the piston 2 is pulled under negative pressure, liquid to be extracted enters the liquid storage space 14 from the liquid suction channel 4 via the openings 15.

The piston 2 is pulled into the axial motion assembly 1 by the connecting cover 21. The whole axial motion assembly 1 moves down, whereby the openings 15 are communicated with the outflow channel 5. After the shoulder 16 is blocked by the partition board 62 in the middle of the bracket 6, the axial motion assembly 1 does not move down any longer. The piston 2 pushes liquid in the liquid storage space 14 to flow out from the outflow channel 5 via the openings 15.

Similarly, the axial motion assembly 1 in this embodiment is simple in structure, multifunctional, and mass-producible. The production cost can be reduced due to no requirements on product materials. A small number of simple components are required to match the pump head element, thus facilitating production and assembly.

### Embodiment 4

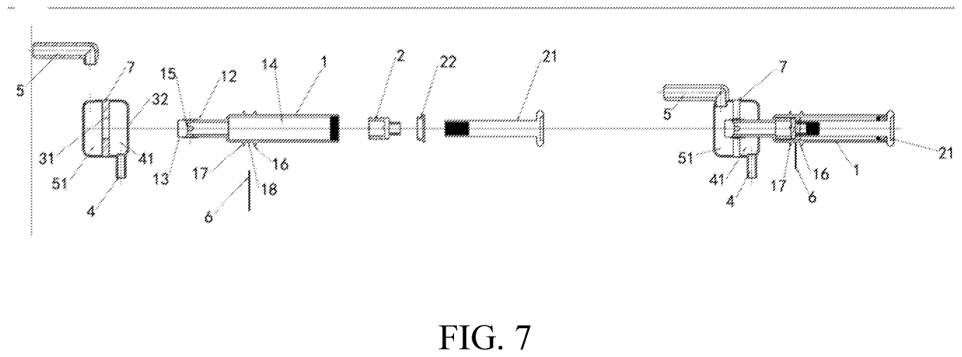

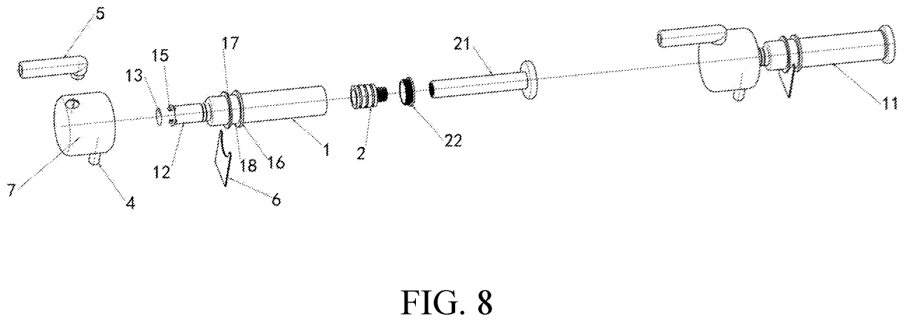

FIG. 7 and FIG. 8 show a pump head according to Embodiment 4. FIG. 7 is a sectional view and an exploded view of a pump head of Embodiment 4. FIG. 8 is a perspective view and an exploded view of the pump head of Embodiment 4. The pump head includes an axial motion assembly 1 (namely, a pump head element), a piston 2, a liquid suction channel 4, an outflow channel 5, a bracket 6, a connecting rod 21, and a cover 22.

The axial motion assembly 1 includes a liquid buffer portion 11, an opening portion 12, and a closed end 13. The opening portion 12 has both an end communicated with the liquid buffer portion 11 and an end connected to the closed end 13. The liquid buffer portion 11 is cylindrical, is externally provided with a protrusion comprising a blocking ring 16 and a blocking ring 17, and is internally provided with a smooth surface matching the piston 2. Internal spaces of the liquid buffer portion 11 and the opening portion 12 are defined as a liquid storage space 14. The liquid storage space 14 has both an end closed by the piston 2 and an end closed by the closed end 13. The opening portion 12 is provided with a plurality of openings 15, and liquid to be extracted enters or leaves the liquid storage space 14 via the openings 15. The axial motion assembly 1 is externally provided with the blocking ring 16 and the blocking ring 17, and the axial motion assembly 1 is partially peripherally provided with a smooth support surface 18 parallel to the axis of the liquid buffer portion. The bracket 6 supports the support surface 18 to support the whole axial reciprocating motion of the axial motion assembly 1. The liquid buffer portion 11 has a greater aperture than the opening portion 12 and the closed end 13, and the opening portion 12 has the same aperture as the closed end 13.

The piston, the liquid buffer portion 11, the opening portion 12, and the closed end 13 coincide axially. The plurality of openings 15 are provided at the same axial position of the opening portion. The liquid buffer portion 11 is externally provided with the blocking ring 16 and the blocking ring 17. The blocking ring 16 and the blocking ring 17 match the bracket 6 to limit an axial movement distance of the axial motion assembly 1. The axial motion assembly 1 is partially peripherally provided with the support surface 18 capable of supporting the whole axial reciprocating motion of the axial motion assembly 1.

An outlet 41 of the liquid suction channel 4 and an inlet 51 of the outflow channel 5 are provided at both sides of an annular frame 7, and the inlet 51 of the outflow channel 5 is located outside. The frame 7 is internally provided with a position for mounting a sealing component 31. The sealing component 31 is capable of reciprocating the opening portion and the closed end of the axial motion assembly 1 while closing a gap between the outlet 41 of the liquid suction channel 4 and the inlet 51 of the outflow channel 5 to prevent mixed flow. After the opening portion 12 and the closed end 13 of the axial motion assembly 1 are mounted on the frame 7, a mounting port is sealed by a sealing component 32. The cover 22 is beneficial for the connecting rod 21 to maintain linear motion without shaking.

The piston 2 is pulled out of the axial motion assembly 1 by the connecting rod 21. The axial motion assembly 1 moves right, whereby the openings 15 are communicated with the liquid suction channel 4. The piston 2 is continuously pulled, the blocking ring 17 is blocked by the bracket 6, and the axial motion assembly 1 does not move right any longer. Under the pulling of the piston 2, liquid to be extracted enters the liquid storage space 14 from the liquid suction channel 4 via the openings 15.

The piston 2 is pulled into the axial motion assembly 1 by the connecting rod 21. The axial motion assembly 1 moves left, whereby the openings 15 are communicated with the outflow channel 5. The piston 2 is continuously pulled, the blocking ring 16 is blocked by the bracket 6, and the axial motion assembly 1 does not move left any longer. The piston 2 pushes liquid in the liquid storage space 14 to flow out from the outflow channel 5 via the openings 15.

While the embodiments of the present disclosure have been shown and described, it will be appreciated by a person of ordinary skill in the art that various changes, modifications, substitutions, and variations may be made to these embodiments without departing from the essence of the present disclosure. The scope of the present disclosure is defined by the appended claims and their equivalents.

What is claimed is:

1. A pump head element, comprising a liquid buffer portion, an opening portion, and a closed end, wherein the liquid buffer portion, the opening portion, and the c closed end are sequentially connected; the opening portion has both an end communicated with the liquid buffer portion and an end connected to the closed end;
internal spaces of the liquid buffer portion and the opening portion are defined as a liquid storage space;
the liquid storage space has both an end closed by an external piston and an end closed by the closed end; and
the opening portion is provided with openings, and liquid to be extracted enters or leaves the liquid storage space via the openings.

2. The pump head element according to claim 1, wherein the openings are a plurality of openings at the same axial position of the opening portion.

3. The pump head element according to claim 1, wherein the openings have a smaller aperture than other parts of the opening portion.

4. The pump head element according to claim 1, wherein the liquid buffer portion, the opening portion, and the closed end coincide axially.

5. The pump head element according to claim 1, wherein the liquid buffer portion is cylindrical, is externally provided with a protrusion, and is internally provided with a smooth surface matching the piston.

6. The pump head element according to claim 1, wherein the liquid buffer portion is partially peripherally provided with a smooth support surface parallel to the axis of the liquid buffer portion.

7. The pump head element according to claim 1, wherein the liquid buffer portion has a greater diameter than the opening portion and the closed end; or, the opening portion has a greater diameter than the closed end.

8. The pump head element according to claim 1, wherein both axial sides of the openings are provided with positions for mounting sealing components; or, both axial sides of the openings are provided with convex rib rings for fixing the sealing components.

9. A pump head, comprising the pump head element according to claim 1.

10. A container, comprising the pump head according to claim 9.

11. The pump head element according to claim 1, wherein the pump head element is used for temporarily storing the liquid to be taken.

12. The pump head according to claim 9, wherein the pump head element can move axially and reciprocally as a whole within the pump head when in use, so that the opening of the pump head element is respectively connected to a liquid suction channel or an outflow channel of the pump head.

13. The pump head according to claim 12, wherein axial reciprocating movement of the pump head element is driven by the movement of the external piston.
